(19) United States
(12) Patent Application Publication
(10) Pub. No.: US 2006/0236837 A1
(43) Pub. Date: Oct. 26, 2006

(54) Pre-cutting blade assembly for table saw

(75) Inventor: Wang Tien Wang, Taichung County (TW)

Correspondence Address: CHARLES E. BAXLEY, ESQ., 90 JOHN STREET, THIRD FLOOR, NEW YORK, NY, 10038, US

(73) Assignee: MAO SHAN MACHINERY INDUSTRIAL CO., LTD.

(21) Appl. No.: 11/111,547

(22) Filed: Apr. 20, 2005

(51) Int. Cl. B26D 1/00

(52) U.S. Cl. 83/651

(57) ABSTRACT

A pre-cutting blade assembly for a table saw includes a fixing seat, a movable seat movably and adjustably mounted on the fixing seat, and a pre-cutting blade mounted on the movable seat to move therewith and movable to align with the circular blade of the table saw. Thus, the pre-cutting blade is movable relative to the circular blade of the table saw so that the cutting line of the pre-cutting blade is aligned with that of the circular blade of the table saw exactly, thereby enhancing the cutting precision of the circular blade of the table saw.

### BACKGROUND OF THE INVENTION

1. Field of the Invention

The present invention relates to a pre-cutting blade assembly, and more particularly to a pre-cutting blade assembly for a table saw.

2. Description of the Related Art

A conventional table saw comprises a saw base, and a circular blade mounted on the saw base and rotatable at a high speed for cutting a wooden material. An alignment line is drawn on the surface of the wooden material so as to facilitate a user operating the circular blade to cut the wooden material. However, the circular blade cannot cut the wooden material exactly due to vibration produced during the cutting process, thereby decreasing the cutting precision of the circular blade.

### SUMMARY OF THE INVENTION

The present invention is to mitigate and/or obviate the disadvantage of the conventional table saw.

The primary objective of the present invention is to provide a pre-cutting blade assembly that can adjust the pre-cutting position of the pre-cutting blade relative to the circular blade of the table saw, thereby facilitating a user operating the table saw.

Another objective of the present invention is to provide a pre-cutting blade assembly, wherein the pre-cutting blade is movable relative to the circular blade of the table saw so that the cutting line of the pre-cutting blade is aligned with that of the circular blade of the table saw exactly, thereby enhancing the cutting precision of the circular blade of the table saw.

A further objective of the present invention is to provide a pre-cutting blade assembly, wherein the pre-cutting blade is pivoted upward and downward relative to the fixing seat so as to adjust the pre-cutting depth (or height) of the pre-cutting blade, thereby enhancing the cutting efficiency of the circular blade of the table saw.

In accordance with the present invention, there is provided a pre-cutting blade assembly, comprising:

a fixing seat;

a movable seat movably and adjustably mounted on the fixing seat;

a pre-cutting blade mounted on the movable seat to move therewith and movable to align with the circular blade of the table saw.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pre-cutting blade assembly for a table saw in accordance with the preferred embodiment of the present invention;

FIG. 2 is a perspective view of the pre-cutting blade assembly in accordance with the preferred embodiment of the present invention;

FIG. 3 is an exploded perspective view of the pre-cutting blade assembly as shown in FIG. 2;

FIG. 4 is a top plan view of the pre-cutting blade assembly as shown in FIG. 2;

FIG. 5 is a plan cross-sectional view of the pre-cutting blade assembly as shown in FIG. 4;

FIG. 6 is a schematic operational view of the pre-cutting blade assembly as shown in FIG. 5;

FIG. 7 is a side plan view of the pre-cutting blade assembly as shown in FIG. 2;

FIG. 8 is a schematic operational view of the pre-cutting blade assembly as shown in FIG. 7; and

FIG. 9 is a schematic operational view of the pre-cutting blade assembly as shown in FIG. 8.

### DETAILED DESCRIPTION OF THE INVENTION

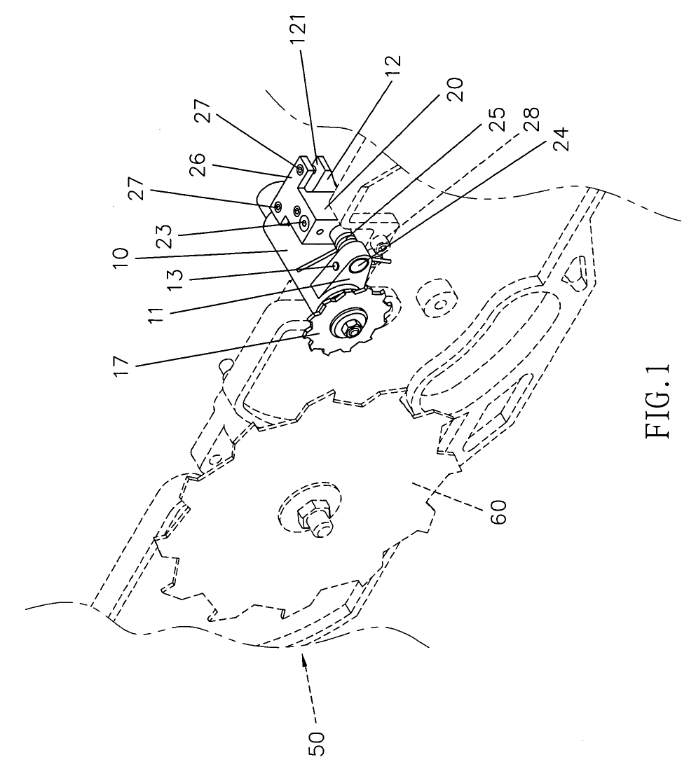

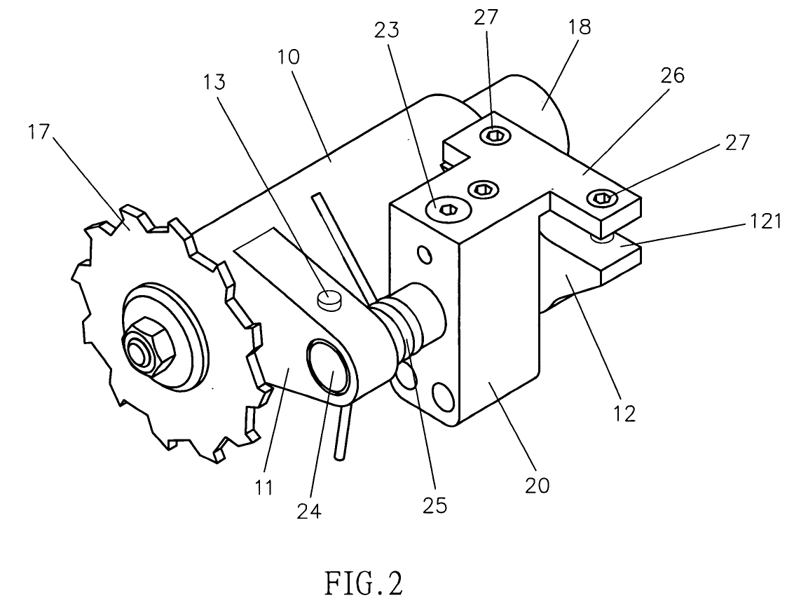

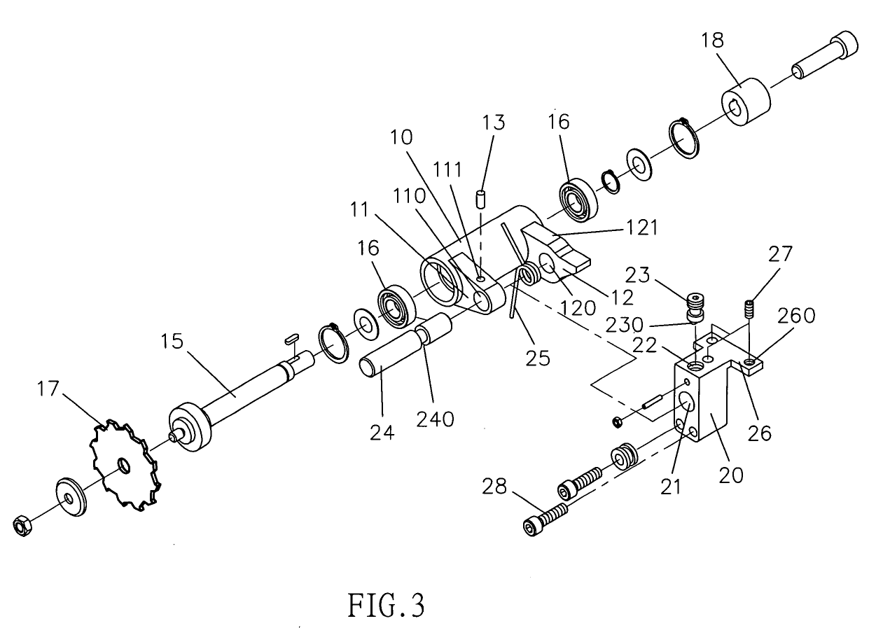

Referring to the drawings and initially to FIGS. 1-3, a pre-cutting blade assembly for a table saw in accordance with the preferred embodiment of the present invention comprises a fixing seat 20 locked on a saw base 50 of the table saw by a plurality of locking bolts 28 and located in front of a circular blade 60 of the saw base 50 of the table saw, a movable seat 10 movably and adjustably mounted on the fixing seat 20, and a pre-cutting blade 17 mounted on the movable seat 10 to move therewith and movable to align with the circular blade 60 of the table saw.

A link 24 is movably mounted on the fixing seat 20, and the movable seat 10 is secured on the link 24 to move therewith. The movable seat 10 has a cylindrical shape and has an outer wall formed with a first ear 11 secured on the link 24 and a second ear 12 spaced from the first ear 11 and mounted on the link 24. A retaining pin 13 is extended through the first ear 11 of the movable seat 10 and has a distal end rested on the link 24 to fix the first ear 11 of the movable seat 10 on the link 24. The first ear 11 of the 11 movable seat 10 has an inside formed with a first shaft hole 110 for mounting the link 24 and has a periphery formed with a pin hole 111 connected to the first shaft hole 110 for mounting the retaining pin 13. The second ear 12 of the movable seat 10 has an inside formed with a second shaft hole 120 for mounting the link 24 and has a top formed with a flattened face 121. A shaft 15 is rotatably mounted in the movable seat 10 by two bearings 16, the pre-cutting blade 17 is mounted on a first end of the shaft 15 to rotate therewith, and a belt wheel 18 is mounted on a second end of the shaft 15 and driven by a driving unit (not shown) to rotate the shaft 15.

The fixing seat 20 has an inside formed with a shaft bore 21 for mounting the link 24. An adjusting threaded rod 23 is rotatably mounted on the fixing seat 20 and has a distal end provided with an eccentric cam 230 rested on the link 24 to move the link 24 relative to the fixing seat 20 by rotation of the adjusting threaded rod 23. The link 24 has a periphery formed with a retaining groove 240 for mounting the eccentric cam 230 of the adjusting threaded rod 23 so that the link 24 is moved with the eccentric cam 230 of the adjusting threaded rod 23. The fixing seat 20 has an end face formed with a screw bore 22 connected to the shaft bore 21, and the adjusting threaded rod 23 is screwed into the screw bore 22 of the fixing seat 20.

The fixing seat 20 has a side formed with a protruding plate 26 located above the second ear 12 of the movable seat 10. The pre-cutting blade assembly further comprises a plurality of retaining bolts 27 each extended through the protruding plate 26 of the fixing seat 20 and each having a distal end rested on the flattened face 121 of the second ear 12 of the movable seat 10. One of the retaining bolts 27 is rotatably movable on the protruding plate 26 of the fixing seat 20 to press the flattened face 121 of the second ear 12 of the movable seat 10 to drive the movable seat 10 to pivot relative to the fixing seat 20 about the link 24. The protruding plate 26 of the fixing seat 20 is formed with a plurality of screw holes 260, and each of the retaining bolts 27 is screwed into a respective one of the screw holes 260 of the fixing seat 20. A torsion spring 25 is mounted on the link 24 and biased between the movable seat 10 and the fixing seat 20 to provide a restoring force to the movable seat 10 to drive the movable seat 10 to move backward to the original position relative to the fixing seat 20.

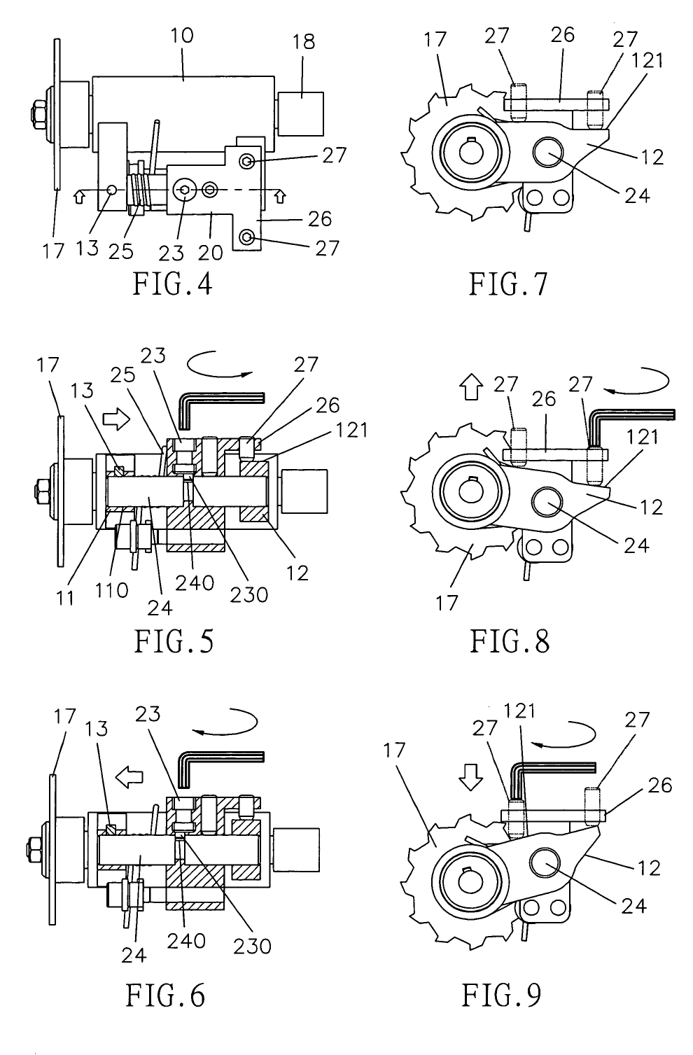

In operation, referring to FIGS. 4-6 with reference to FIGS. 1-3, when the cutting line of the pre-cutting blade 17 is not aligned with that of the circular blade 60 of the table saw, the adjusting threaded rod 23 is rotated by a wrench to rotate the eccentric cam 230 which is moved eccentrically to drive the link 24 to move relative to the fixing seat 20 rightward and leftward. At this time, the movable seat 10 is fixed on the link 24 by the retaining pin 13, so that the movable seat 10 is movable with the link 24 to drive the pre-cutting blade 17 to move rightward and leftward so that the cutting line of the pre-cutting blade 17 is aligned with that of the circular blade 60 of the table saw exactly, thereby enhancing the cutting precision of the circular blade 60 of the table saw.

Alternatively, referring to FIGS. 7-9 with reference to FIGS. 1-3, when the user wishes to adjust the pre-cutting depth (or height) of the pre-cutting blade 17, one of the retaining bolts 27 is rotated by a wrench to move downward to press the flattened face 121 of the second ear 12 of the movable seat 10 as shown in FIG. 8 to drive the movable seat 10 to pivot relative to the fixing seat 20 about the link 24 so that the pre-cutting blade 17 is pivoted upward relative to the fixing seat 20, thereby adjusting the pre-cutting depth (or height) of the pre-cutting blade 17. On the contrary, the one of the retaining bolts 27 is rotated by the wrench to move upward to release the flattened face 121 of the second ear 12 of the movable seat 10 so that the movable seat 10 is pivoted backward relative to the fixing seat 20 by the restoring force of the torsion spring 25 to return to the original position as shown in FIG. 9. At this time, another one of the retaining bolts 27 is rotated by the wrench to move downward to press the flattened face 121 of the second ear 12 of the movable seat 10 so as to retain the movable seat 10 in place.

Accordingly, the pre-cutting blade 17 is movable relative to the circular blade 60 of the table saw so that the cutting line of the pre-cutting blade 17 is aligned with that of the circular blade 60 of the table saw exactly, thereby enhancing the cutting precision of the circular blade 60 of the table saw. In addition, the pre-cutting blade 17 is pivoted upward and downward relative to the fixing seat 20 so as to adjust the pre-cutting depth (or height) of the pre-cutting blade 17, thereby enhancing the cutting efficiency of the circular blade 60 of the table saw.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A pre-cutting blade assembly, comprising:
a fixing seat;
a movable seat movably and adjustably mounted on the fixing seat;
a pre-cutting blade mounted on the movable seat to move therewith and movable to align with the circular blade of the table saw.

2. The pre-cutting blade assembly in accordance with claim 1, further comprising a link movably mounted on the fixing seat, wherein the movable seat is secured on the link to move therewith.

3. The pre-cutting blade assembly in accordance with claim 2, wherein the movable seat has an outer wall formed with a first ear secured on the link and a second ear spaced from the first ear and mounted on the link.

4. The pre-cutting blade assembly in accordance with claim 3, further comprising a retaining pin extended through the first ear of the movable seat and having a distal end rested on the link to fix the first ear of the movable seat on the link.

5. The pre-cutting blade assembly in accordance with claim 4, wherein the first ear of the movable seat has an inside formed with a first shaft hole for mounting the link and has a periphery formed with a pin hole connected to the first shaft hole for mounting the retaining pin.

6. The pre-cutting blade assembly in accordance with claim 3, wherein the second ear of the movable seat has an inside formed with a second shaft hole for mounting the link.

7. The pre-cutting blade assembly in accordance with claim 1, wherein the movable seat has a cylindrical shape.

8. The pre-cutting blade assembly in accordance with claim 1, further comprising a shaft rotatably mounted in the movable seat by two bearings, wherein the pre-cutting blade is mounted on a first end of the shaft to rotate therewith, and a belt wheel is mounted on a second end of the shaft to rotate the shaft.

9. The pre-cutting blade assembly in accordance with claim 2, further comprising an adjusting threaded rod rotatably mounted on the fixing seat and having a distal end provided with an eccentric cam rested on the link to move the link relative to the fixing seat by rotation of the adjusting threaded rod.

10. The pre-cutting blade assembly in accordance with claim 9, wherein the fixing seat has an inside formed with a shaft bore for mounting the link, and the fixing seat has an end face formed with a screw bore connected to the shaft bore, and the adjusting threaded rod is screwed into the screw bore of the fixing seat.

11. The pre-cutting blade assembly in accordance with claim 9, wherein the link has a periphery formed with a retaining groove for mounting the eccentric cam of the adjusting threaded rod so that the link is moved with the eccentric cam of the adjusting threaded rod.

12. The pre-cutting blade assembly in accordance with claim 1, wherein second ear of the movable seat has a top formed with a flattened face, the fixing seat has a side formed with a protruding plate located above the second ear of the movable seat, and the pre-cutting blade assembly further comprises a plurality of retaining bolts each extended through the protruding plate of the fixing seat and each having a distal end rested on the flattened face of the second ear of the movable seat.

13. The pre-cutting blade assembly in accordance with claim 12, wherein one of the retaining bolts is rotatably movable on the protruding plate of the fixing seat to press the flattened face of the second ear of the movable seat to drive the movable seat to pivot relative to the fixing seat about the link.

14. The pre-cutting blade assembly in accordance with claim 12, wherein the protruding plate of the fixing seat is formed with a plurality of screw holes, and each of the retaining bolts is screwed into a respective one of the screw holes of the fixing seat.

15. The pre-cutting blade assembly in accordance with claim 2, further comprising a torsion spring mounted on the link and biased between the movable seat and the fixing seat to provide a restoring force to the movable seat to drive the movable seat to move relative to the fixing seat.
